(19) United States
(12) Patent Application Publication
(10) Pub. No.: US 2016/0102788 A1
(43) Pub. Date: Apr. 14, 2016

(54) TRANSMITTER MOUNTING SYSTEM AND METHOD OF MOUNTING

(71) Applicant: General Electric Company, Schenectady, NY (US)

(72) Inventors: Christopher Scott Cox, Greenville, SC (US); Douglas Scott Byrd, Greer, SC (US); Ryan Jean Derouin, Johns Creek, GA (US); Allen Grayson Sparks, Cornelius, NC (US)

(21) Appl. No.: 14/509,658

(22) Filed: Oct. 8, 2014

(51) Int. Cl. F16L 15/00

(52) U.S. Cl. CPC F16L 15/00

(57) ABSTRACT

A mounting adaptor for mounting a transmitter to a valve manifold includes a base portion having a first side and a second side, the first side having a flat surface. Also included is a connector portion having a threaded external surface, the connector portion operatively coupled to, and extending away from, the second side of the base portion. Further included is at least one through hole defined by the base portion, the at least one through hole extending from the first side to the second side and configured to mount the mounting adaptor to the valve manifold.

### BACKGROUND OF THE INVENTION

The subject matter disclosed herein relates to mounting systems for transmitters and, more particularly, to a mounting adaptor for mounting a transmitter to a valve manifold, as well as a method of mounting a transmitter to a valve manifold.

Control systems are employed to monitor and control industrial processes used to produce or transfer fluids or the like. In such systems, it is typically important to measure “process variables” such as temperatures, pressures, flow rates, and others. Process control transmitters are used to measure such process variables and transmit information related to the measured process variable back to a central location such as a central control room, for example.

Pressure transmitters typically offer threaded connections to the process or piping to be measured. Unfortunately, many applications require a flanged manifold without threads, such that the threaded connector of the transmitter must be modified or retrofitted in some manner to facilitate connection to the flat valve manifold flange.

### BRIEF DESCRIPTION OF THE INVENTION

According to one aspect of the invention, a transmitter mounting system including a transmitter having a threaded connector region. Also included is a valve manifold having a flat mounting flange to be operatively coupled to the transmitter. Further included is a mounting adaptor configured to mount the transmitter to the flat mounting flange of the valve manifold. The mounting adaptor includes a base portion having a first side and a second side, the first side having a flat surface and configured to engage the flat mounting flange of the valve manifold. The mounting adaptor also includes a connector portion having a threaded external surface, the connector portion integrally formed with, and extending away from, the second side of the base portion, the threaded external surface configured to engage the threaded connector region of the transmitter. The mounting adaptor further includes at least one through hole defined by the base portion, the at least one through hole extending from the first side to the second side and configured to mount the mounting adaptor to the valve manifold.

According to another aspect of the invention, a mounting adaptor for mounting a transmitter to a valve manifold includes a base portion having a first side and a second side, the first side having a flat surface. Also included is a connector portion having a threaded external surface, the connector portion operatively coupled to, and extending away from, the second side of the base portion. Further included is at least one through hole defined by the base portion, the at least one through hole extending from the first side to the second side and configured to mount the mounting adaptor to the valve manifold.

According to yet another aspect of the invention, a method of mounting a transmitter to a valve manifold of a gas turbine engine is provided. The method includes placing a flat first side of a base portion of a mounting adaptor into flush contact with a flat mounting flange of the valve manifold. The method also includes fixing the mounting adaptor to the flat mounting flange with at least one mechanical fastener extending through at least one through hole defined by the base portion and extending from the first flat side of the base portion to a second side. The method further includes connecting the mounting adaptor to a threaded connector region of the transmitter with a connector portion of the mounting adaptor that is integrally formed with, and extends from, the second side of the mounting adaptor.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a transmitter;

FIG. 2 is a side elevation view of a transmitter mounting system;

FIG. 3 is a perspective view of a mounting adaptor of the transmitter mounting system;

FIG. 4 is a side elevation view of the mounting adaptor; and

FIG. 5 is a perspective view of the mounting adaptor according to another aspect.

The detailed description explains embodiments of the invention, together with advantages and features, by way of example with reference to the drawings.

### DETAILED DESCRIPTION OF THE INVENTION

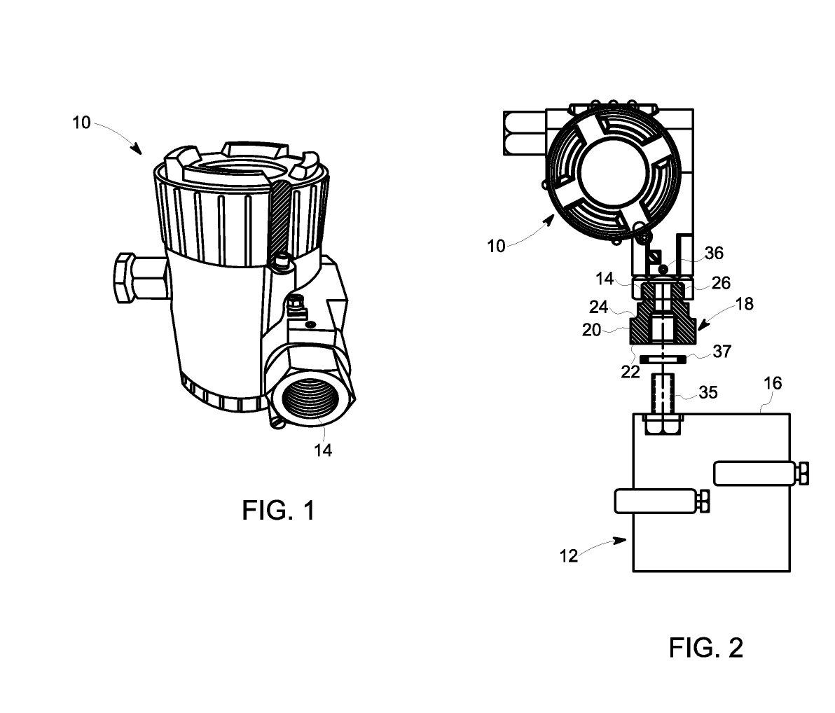

Referring to FIGS. 1 and 2, illustrated is an exemplary embodiment of a transmitter 10 that is configured to be operatively coupled to a component or system 12 and to detect a system condition. Examples of detected conditions include pressure, temperature, and flow rate. The transmitter 10 may be used in conjunction with various contemplated systems, including a turbine system such as a gas turbine engine. The transmitter 10, when coupled to the component or system 12, receives a process fluid to be evaluated. The transmitter 10 includes various detection and communication components, such as sensors, circuitry, and a communication bus. The detected information may be processed within the transmitter 10, but is typically transmitted to another component and is powered over a control loop by a controller. Other communication techniques may also be employed including wireless techniques.

The transmitter 10 includes a threaded connector region 14 that is configured to operatively couple the transmitter 10 to the component or system 12. In one embodiment, the component or system 12 is a valve manifold that requires pressure monitoring, such that the transmitter 10 is a pressure transmitter. In some embodiments of the component or system 12, the portion to be coupled to the transmitter is a flat mounting flange 16. In such embodiments, it is undesirable to modify the flat mounting flange 16 or the threaded connector region 14.

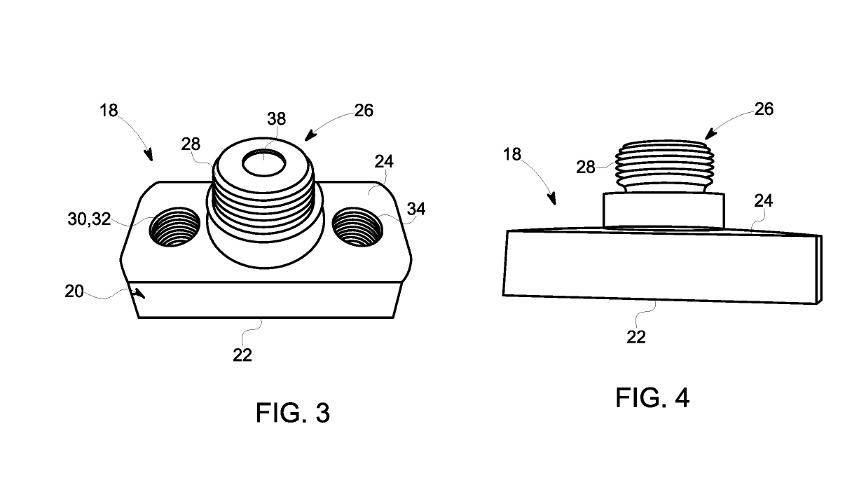

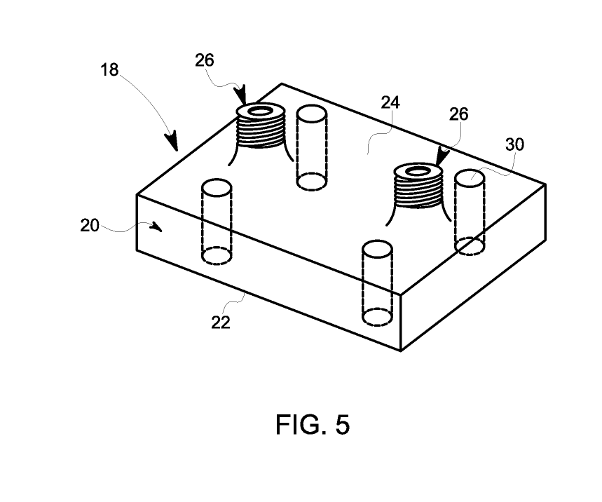

Referring now to FIGS. 3 and 4, a mounting adaptor 18 is provided to operatively couple the transmitter 10 to the component or system 12. Specifically, the mounting adaptor 18 couples to the threaded connector region 14 of the transmitter 10 and to the flat mounting flange 16 of the component or system 12. The mounting adaptor 18 is a single, uniform component that may be made of various suitable materials, typically a metal. The mounting adaptor 18 includes a base portion 20 having a first side 22 and a second side 24. The first side 22 is a flat surface that is configured to be placed into contact with the flat mounting flange 16 of the component or system 12. The second side 24 of the base portion 20 includes a connector portion 26 extending therefrom. The connector portion 26 is typically located proximate a central location of the second side 24 of the base portion 20, but such a location is not required, particularly if a plurality of connector portions are included, as shown in FIG. 5. The illustrated embodiment of FIG. 5 depicts two connector portions, but as one can appreciate more connector portions may be included.

Regardless of the number of connector portions, the connector portion 26 has a threaded external surface 28 that is configured to engage and couple to the threaded connector region 14 of the transmitter 10. It is to be appreciated that alternative threaded configurations may be employed other than that illustrated. Specifically, the threaded external surface 28 and the threaded connector region 14 may be male or female threads. Furthermore, the threaded external surface 28 and/or the threaded connector region 14 may be tapered, straight, parallel, or any other suitable orientation. The connector portion 26 defines a process fluid aperture 38 that facilitates the transfer of fluid to be analyzed by the transmitter 10 between the valve manifold and the transmitter 10.

At least one through hole 30 extends completely through the base portion 20 from the first side 22 to the second side 24. In the illustrated embodiment, two through holes are shown and referred to as a first hole 32 and a second hole 34 that are disposed on opposite sides of the connector portion 26. It is to be understood that any number of holes may be present. Irrespective of the precise number of holes, the at least one through hole 30 is threaded and configured to receive a fastener 35 therethrough to secure the mounting adaptor 18 to the component or system 12 and specifically to the flat mounting flange 16. The fastener 35 may be a bolt or the like that extends into the at least one through hole 30 and through a portion of the flat mounting flange 16. A sealing member 37, such as an O-ring, is disposed between the first side 22 of the mounting adaptor 18 and the flat mounting flange 16 to establish a sealed coupling of the components.

With reference to FIG. 2, an orientation fastener 36 is provided to ensure a desired orientation of the mounting adaptor 18 relative to the transmitter 10. The orientation fastener 36 extends through the transmitter 10 proximate the threaded connector region 14 and through the connector portion 26 of the mounting adaptor 18 to orient the mounting adaptor 18 in a predetermined angular position.

In operation, the mounting adaptor 18 operatively couples the transmitter 10 to the flat mounting flange 16, while advantageously avoiding the need to redesign the transmitter and/or flat mounting flange 16 for successful mating of the components. Therefore, selection of commercially available transmitters is increased due to the ability to mount threaded connector transmitters to flat flanges, such as the flat mounting flange 16 of the embodiments described herein.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A transmitter mounting system comprising:
a transmitter having a threaded connector region;
a valve manifold having a flat mounting flange to be operatively coupled to the transmitter; and
a mounting adaptor configured to mount the transmitter to the flat mounting flange of the valve manifold, the mounting adaptor comprising:
a base portion having a first side and a second side, the first side having a flat surface and configured to engage the flat mounting flange of the valve manifold;
a connector portion having a threaded external surface, the connector portion integrally formed with, and extending away from, the second side of the base portion, the threaded external surface configured to engage the threaded connector region of the transmitter; and
at least one through hole defined by the base portion, the at least one through hole extending from the first side to the second side and configured to mount the mounting adaptor to the valve manifold.

2. The transmitter mounting system of claim 1, wherein the at least one through hole is threaded and configured to receive a fastener for securing the mounting adaptor to the valve manifold.

3. The transmitter mounting system of claim 2, wherein the fastener is a bolt extending through the flat mounting flange of the valve manifold and into the at least one through hole.

4. The transmitter mounting system of claim 1, wherein the at least one through hole comprises a first through hole and a second through hole disposed on opposite sides of the connector portion.

5. The transmitter mounting system of claim 1, further comprising a plurality of connector portions integrally formed with and extending from the second side of the base portion.

6. The transmitter mounting system of claim 1, further comprising an O-ring disposed between the first side of the base portion of the mounting adaptor and the flat mounting flange of the valve manifold.

7. The transmitter mounting system of claim 1, further comprising an orientation fastener extending through the transmitter proximate the threaded connector region and through the connector portion of the mounting adaptor to orient the mounting adaptor in a predetermined angular position.

8. The transmitter mounting system of claim 1, wherein the transmitter comprises a pressure transmitter.

9. The transmitter mounting system of claim 1, wherein the transmitter mounting system is operatively coupled to a gas turbine engine.

10. A mounting adaptor for mounting a transmitter to a valve manifold comprising:
a base portion having a first side and a second side, the first side having a flat surface;
a connector portion having a threaded external surface, the connector portion operatively coupled to, and extending away from, the second side of the base portion; and
at least one through hole defined by the base portion, the at least one through hole extending from the first side to the second side and configured to mount the mounting adaptor to the valve manifold.

11. The mounting adaptor of claim 10, wherein the connector portion is integrally formed with the base portion and is configured to engage a threaded connector region of the transmitter.

12. The mounting adaptor of claim 10, wherein the at least one through hole is threaded and configured to receive a fastener for securing the mounting adaptor to the valve manifold.

13. The mounting adaptor of claim 12, wherein the fastener is a bolt extending through a flat mounting flange of the valve manifold and into the at least one through hole.

14. The mounting adaptor of claim 10, wherein the at least one through hole comprises a first through hole and a second through hole disposed on opposite sides of the connector portion.

15. The mounting adaptor of claim 10, further comprising a plurality of connector portions integrally formed with and extending from the second side of the base portion.

16. The mounting adaptor of claim 10, further comprising an O-ring disposed between the first side of the base portion of the mounting adaptor and a flat mounting flange of the valve manifold.

17. The mounting adaptor of claim 11, further comprising an orientation fastener extending through the transmitter proximate the threaded connector region and through the connector portion of the mounting adaptor to orient the mounting adaptor in a predetermined angular position.

18. The mounting adaptor of claim 10, wherein the transmitter comprises a pressure transmitter.

19. The mounting adaptor of claim 10, wherein the valve manifold is operatively coupled to a gas turbine engine and the transmitter is configured to detect a pressure.

20. The mounting adaptor of claim 15, wherein the at least one through hole comprises a first pair of through holes located on opposing sides of a first connector portion and a second pair of through holes located on opposing sides of a second connector portion.
